(19) United States
(12) Patent Application Publication
(10) Pub. No.: US 2005/0285314 A1
(43) Pub. Date: Dec. 29, 2005

(54) Integral Nut Slot System In SLS Details

(75) Inventors: John G. Macke Jr., St. Louis, MO (US); Jack G. Buchheit, St. Charles, MO (US); Nancy Samson, St. Charles, MO (US)

Correspondence Address: ARTZ & ARTZ, P.C., 28333 TELEGRAPH RD., SUITE 250, SOUTHFIELD, MI, 48034, US

(73) Assignee: THE BOEING COMPANY, Chicago, IL (US)

(21) Appl. No.: 10/710,231

(22) Filed: Jun. 28, 2004

(51) Int. Cl. B29C 35/08

(52) U.S. Cl. 264/497; 425/174.6

(57) ABSTRACT

A system for manufacturing a tool within a laser sintering system includes a chamber enclosing a sinter material. The laser sintering system grows or sinters a section of the tool from the sinter material in response to signals from a controller. The controller generates the signals as a function of a predetermined tool design. The predetermined tool design includes defining a slot in the section of the tool, wherein the slot receives a weld-nut after sintering is complete for strengthening a portion of the section of the tool.

### FEDERAL RESEARCH STATEMENT

[Federal Research Statement Paragraph]This invention was made with government support on contract N00019-01-C-0012. The Government has certain rights in this invention.

### BACKGROUND OF INVENTION

The present invention relates generally to tooling systems and processes and is more specifically related to the fabrication of tools through selective laser sintering.

Traditional fabrication methods for tools having areas of contour have included fiberglass lay-ups on numerically controlled machined master models or facility details.

A manufacturing master model tool, or “master model”, is a three-dimensional representation of a part or assembly. The master model controls physical features and shapes during the manufacture or “build” of assembly tools, thereby ensuring that parts and assemblies created using the master model fit together.

Traditional tool fabrication methods rely on a physical master model. These master models may be made from many different materials including: steel, aluminum, plaster, clay, and composites; and the selection of a specific material has been application dependent. Master models are usually hand-made and require skilled craftsmen to accurately capture the design intent. Once the master model exists, it may be used to duplicate tools.

The master model becomes the master definition for the contours and edges of a part pattern that the master model represents. The engineering and tool model definitions of those features become reference only.

Root cause analysis of issues within tool families associated with the master has required tool removal from production for tool fabrication coordination with the master. Tools must also be removed from production for master model coordination when repairing or replacing tool details. Further, the master must be stored and maintained for the life of the tool.

Master models are costly in that they require design, modeling and surfacing, programming, machine time, hand work, secondary fabrication operations, and inspection prior to use in tool fabrication.

In summary, although used for years, physical master models have inherent inefficiencies, including: they are costly and difficult to create, use, and maintain; there is a constant risk of damage or loss of the master model; and large master models are difficult and costly to store.

By way of further background, the field of rapid prototyping of parts has, in recent years, made significant improvements in providing high strength, high density parts for use in the design and pilot production of many useful objects. “Rapid prototyping” generally refers to the manufacture of objects directly from computer-aided-design (CAD) databases in an automated fashion, rather than from conventional machining of prototype objects following engineering drawings. As a result, time required to produce prototype parts from engineering designs has been reduced from several weeks to a matter of a few hours.

An example of a rapid prototyping technology is the selective laser sintering process (SLS) in which objects are fabricated from a laser-fusible powder. According to this process, a thin layer of powder is dispensed and then fused, melted, or sintered, by a laser beam directed to those portions of the powder corresponding to a cross-section of the object.

Conventional selective laser sintering systems position the laser beam by way of galvanometer-driven mirrors that deflect the laser beam. The deflection of the laser beam is controlled, in combination with modulation of the laser itself, for directing laser energy to those locations of the fusible powder layer corresponding to the cross-section of the object to be formed in that layer. The laser may be scanned across the powder in a raster fashion or a vector fashion.

In a number of applications, cross-sections of objects are formed in a powder layer by fusing powder along the outline of the cross-section in vector fashion either before or after a raster scan that fills the area within the vector-drawn outline. After the selective fusing of powder in a given layer, an additional layer of powder is then dispensed and the process repeated, with fused portions of later layers fusing to fused portions of previous layers (as appropriate for the object), until the object is completed.

Selective laser sintering has enabled the direct manufacture of three-dimensional objects of high resolution and dimensional accuracy from a variety of materials including polystyrene, NYLON, other plastics, and composite materials, such as polymer coated metals and ceramics. In addition, selective laser sintering may be used for the direct fabrication of molds from a CAD database representation of the object in the fabricated molds. Selective Laser Sintering has, however, not been generally applicable for tool manufacture because of SLS part size limitations, lack if robustness of SLS objects, and inherent limitations in the SLS process.

Further, the SLS material typically does not have sufficient strength or durability to support threaded features. A traditional tooling solution includes adding a metal threaded insert; however, this adds unwanted secondary fabrication operations beyond the primary SLS fabrication and will not prevent stripping of threads in high torque applications.

The disadvantages associated with current tool manufacturing systems have made it apparent that a new and improved tooling system is needed. The new tooling system should reduce need for master models and should reduce time requirements and costs associated with tool manufacture. The new system should also apply SLS technology to tooling applications and strengthen SLS material such that bolts may couple sections of SLS tools together with minimal thread stripping. The present invention is directed to these ends.

### SUMMARY OF INVENTION

In accordance with one aspect of the present invention, a system for manufacturing a tool within a laser sintering system includes a chamber enclosing a sinter material. The laser sintering system grows or sinters a section of the tool from the sinter material in response to signals from a controller. The controller generates the signals as a function of a predetermined tool design. The predetermined tool design includes defining a slot in the section of the tool, wherein the slot receives a weld-nut after sintering is complete for strengthening a portion of the section of the tool.

In accordance with another aspect of the present invention, a method for laser sintering a tool includes predetermining a position of a contoured detail feature. The method further includes predetermining a configuration for the contoured detail feature such that the contoured detail feature includes securing features for coupling strengthening components thereto. The contoured detail is sintered, and a strengthening component is coupled thereto, thereby reducing stress on the contoured detail feature.

One advantage of the present invention is that use of Selective Laser Sintering can significantly reduce costs and cycle time associated with the tool fabrication process. An additional advantage is that tool features can be “grown” as represented by the three-dimensional computer model, thus eliminating the requirement for a master model or facility detail. The subsequent maintenance or storage of the master/facility is thereby also eliminated.

Still another advantage of the present invention is that the model remains the master definition of the tool, therefore root cause analysis or detail replacement may be done directly from the model definition. Secondary fabrication operations are further eliminated where features are “grown” per the three-dimensional solid model definition.

Additional advantages and features of the present invention will become apparent from the description that follows, and may be realized by means of the instrumentalities and combinations particularly pointed out in the appended claims, taken in conjunction with the accompanying drawings.

### BRIEF DESCRIPTION OF DRAWINGS

In order that the invention may be well understood, there will now be described some embodiments thereof, given by way of example, reference being made to the accompanying drawings, in which:

FIG. 1 illustrates a sintering system in accordance with one embodiment of the present invention;

FIG. 2 illustrates a perspective view of a tool, fabricated in the system of FIG. 1, in accordance with another embodiment of the present invention;

FIG. 3 illustrates an enlarged partial view of FIG. 2;

FIG. 4 illustrates a cutaway view of a section of the tool of FIG. 2, looking in the direction of 4-4, in accordance with another embodiment of the present invention;

FIG. 5 illustrates the cutaway view of FIG. 4 including a weld-nut accordance with another embodiment of the present invention;

FIG. 6 illustrates the cutaway view of FIG. 5 including a threaded feature and coupling features in accordance with another embodiment of the present invention; and

FIG. 7 illustrates a logic flow diagram of a method for operating a sintering system in accordance with another embodiment of the present invention.

### DETAILED DESCRIPTION

The present invention is illustrated with respect to a sintering system particularly suited to the aerospace field. The present invention is, however, applicable to various other uses that may require tooling or parts manufacture, as will be understood by one skilled in the art.

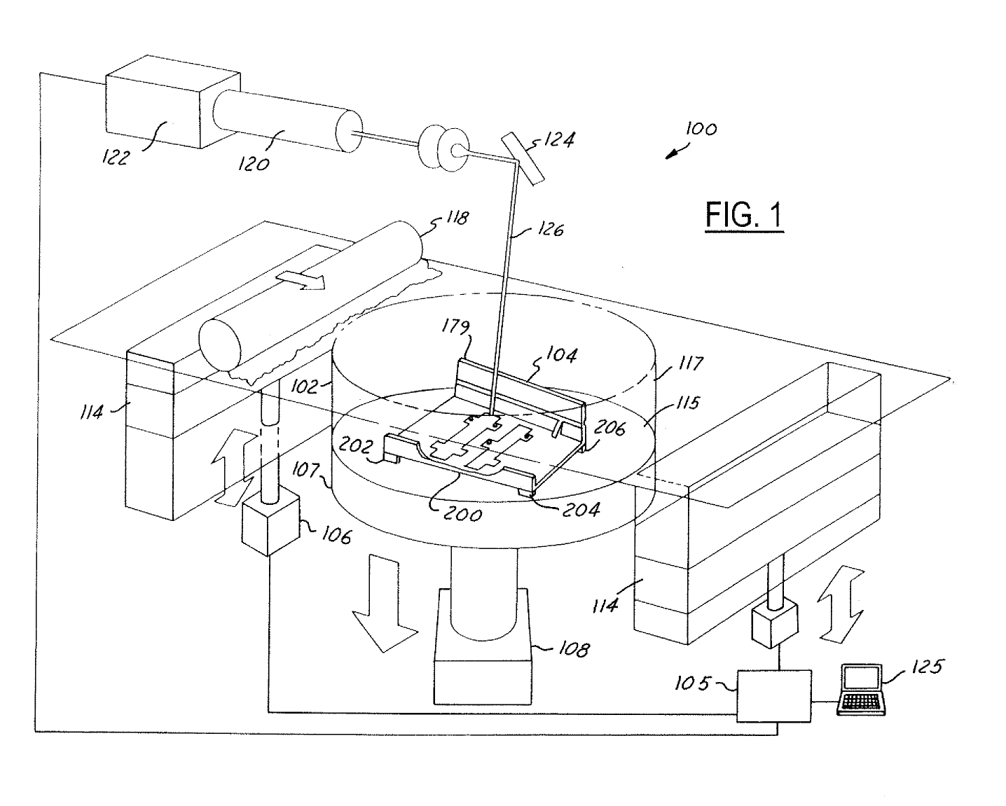

FIG. 1 illustrates a selective laser sintering system 100 having a chamber 102 (the front doors and top of chamber 102 not shown in FIG. 1, for purposes of clarity). The chamber 102 maintains the appropriate temperature and atmospheric composition (typically an inert atmosphere such as nitrogen) for the fabrication of a tool section 104. The system 100 typically operates in response to signals from a controller 105 controlling, for example, motors 106 and 108, pistons 114 and 107, roller 118, laser 120, and mirrors 124, all of which are discussed below. The controller 105 is typically controlled by a computer 125 or processor running, for example, a computer-aided design program (CAD) defining a cross-section of the tool section 102.

The system 100 is further adjusted and controlled through various control features, such as the addition of heat sinks 126, optimal objection orientations, and feature placements, which are detailed herein.

The chamber 102 encloses a powder sinter material that is delivered therein through a powder delivery system. The powder delivery system in system 100 includes feed piston 114, controlled by motor 106, moving upwardly and lifting a volume of powder into the chamber 102. Two powder feed and collection pistons 114 may be provided on either side of part piston 107, for purposes of efficient and flexible powder delivery. Part piston 107 is controlled by motor 108 for moving downwardly below the floor of chamber 102 (part cylinder or part chamber) by small amounts, for example 0.125 mm, thereby defining the thickness of each layer of powder undergoing processing.

The roller 118 is a counter-rotating roller that translates powder from feed piston 114 to target surface 115. Target surface 115, for purposes of the description herein, refers to the top surface of heat-fusible powder (including portions previously sintered, if present) disposed above part piston 107; the sintered and unsintered powder disposed on part piston 107 and enclosed by the chamber 102 will be referred to herein as the part bed 117. Another known powder delivery system feeds powder from above part piston 107, in front of a delivery apparatus such as a roller or scraper.

In the selective laser sintering system 100 of FIG. 1, a laser beam is generated by the laser 120, and aimed at target surface 115 by way of a scanning system 122, generally including galvanometer-driven mirrors 124 deflecting the laser beam 126. The deflection of the laser beam 126 is controlled, in combination with modulation of laser 120, for directing laser energy to those locations of the fusible powder layer corresponding to the cross-section of the tool section 104 formed in that layer. The scanning system 122 may scan the laser beam across the powder in a raster-scan or vector-scan fashion. Alternately, cross-sections of tool sections 104 are also formed in a powder layer by scanning the laser beam 126 in a vector fashion along the outline of the cross-section in combination with a raster scan that “fills” the area within the vector-drawn outline.

Referring to FIGS. 1, 2, and 3, a sample tool 150 formed through the SLS system 100 is illustrated. The tool 150 includes a plurality of large sections (first 152, second 154, and third 156) or alternately one large section. The sections 152 (alternate embodiment of 104 in FIG. 1), 154, 156 may be sintered simultaneously or consecutively.

During the sintering process, various features are molded into the large tool section or sections. Such features include steps and thickness variations 158, gussets 160, stiffeners 162, interfaces and coordination features for making interfaces 164, construction ball interfaces and coordination holes 170, trim of pocket and drill inserts 166, hole patterns 172, and holes 168 included in multiple details for interfacing hardware, such as detail 180. Important to note is that a first plurality of features, including a combination of the aforementioned features, may be sintered into the first section 152 and a second plurality of features, including a combination of the aforementioned features, may be sintered into the second section 154.

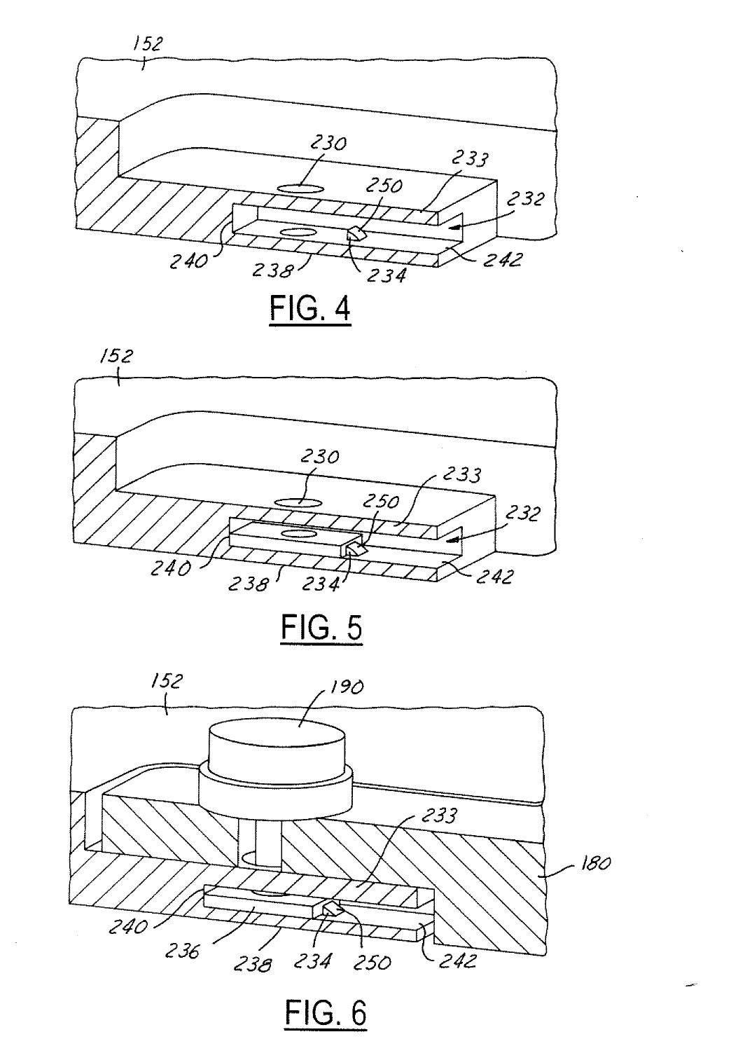

Individually contoured details, such as detail 180, which may also be considered sections of the tool for the purposes of the present invention, may be sintered separately from the main body of the tool 150, such that they may be easily replaced or replaceable or easily redesigned and incorporated in the tool 150. Alternate embodiments include a plurality of individual contoured details, such as 180, 182, 184, and 186. Each of the contoured details includes holes, e.g. 168, such that a bolt 190 may bolt the detail 180 to a section 152, 154, or 156 of the tool 150. The contoured details 180 further define holes or openings 198 strengthened by bushings 200. The openings 198 reduce friction acting on and strengthen the contoured detail 180 such that other tools, tool components, or devices may be coupled thereto. The contoured detail 180 and the bushings 200 will be discussed further regarding FIGS. 4, 5, and 6.

The features, such as the gusset 160 and the stiffener 162 are, in one embodiment of the present invention, grown on the same side of the SLS tool 150. Growing (i.e. sintering) these features on the same side of the tool takes advantage of the sintering process because a feature grown at the beginning of a sintering operation has different properties than the same feature would when grown at the end of a sintering operation. Therefore, the first side 200 undergoing sintering includes all the tool features.

Alternate embodiments of the present invention include various tool features grown on either side of the tool 150 through various other methods developed in accordance with the present invention. One such method includes adding a heat sink 202, or a plurality of heat sinks 202, 204, 206 to various portions of the bed 117 such that different tool features may be cooled subsequent to sintering on the first section 152 or second section 154, thereby avoiding warping that is otherwise inherent in the sintering process. Alternately, a single large heat sink may be placed on one side such that all features cool at the same rate and immediately following the sintering operation.

A further aspect of the present invention includes separating contoured details and various tool aspects by a proximate amount such that warping between the features is limited and structural integrity of the features is maximized.

An alternate embodiment of the present invention includes designing in access features or buffer features 179 in areas where warping will occur during sintering such that these features may be removed when the sintering process is concluded. These buffer features 179 may be predetermined such that connection between them and the main body of the part facilitates detachment through a twisting off or breaking off procedure for the buffer feature 179.

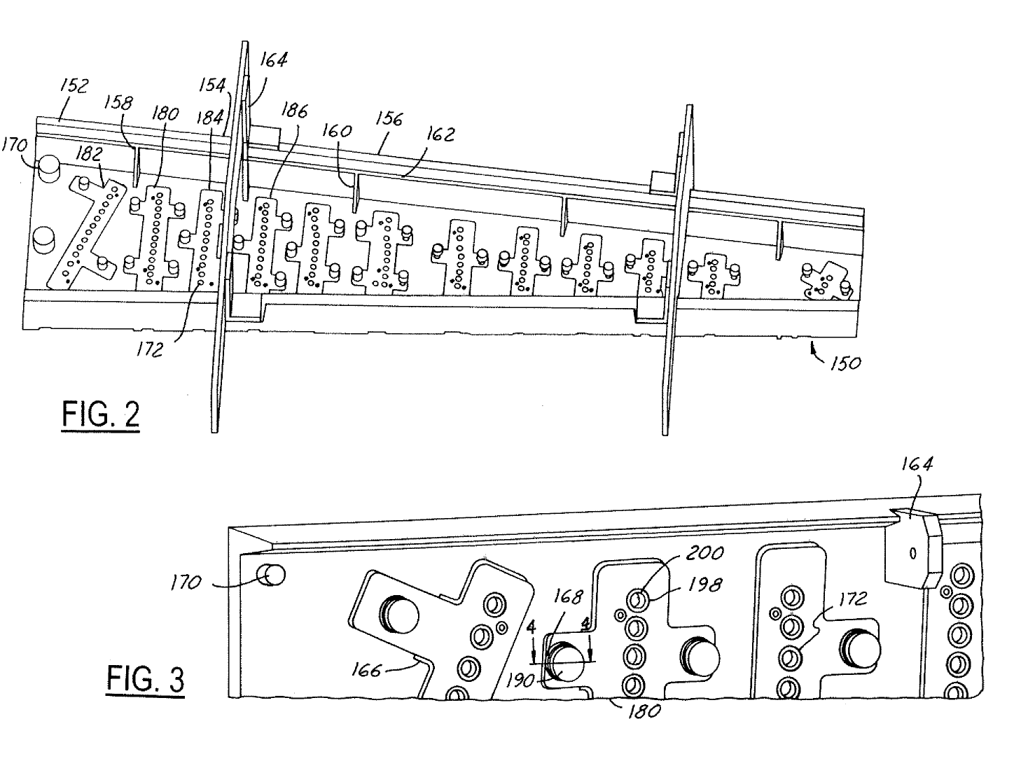

FIGS. 4, 5, and 6 illustrate a partial cutaway view of a section 152 of the tool 150 of FIG. 2, looking in the direction of 4-4, in accordance with another embodiment of the present invention. FIG. 4 illustrates a cutaway view of the section 152 of FIG. 3 looking in the direction of 4-4. The section 152 defines a bolt hole 230 for receiving a bolt, a slot 232, and a retaining detent 234. FIG. 5 illustrates a weld-nut 236 (strengthening feature) inserted in the slot 232 and secured by the retaining detent 234. FIG. 6 illustrates the contoured detail 180 coupled to the section 152 through a bolt 190 secured through the hole 230 and bolted to the weld-nut 236.

The bolt hole 230 is defined in the section 152, such that a bolt 190 extending there through intersects the slot 232. The bolt hole 230 may extend fully through the slot 232 or alternately partially through the slot 232 provided the bolt hole extends at least through a ceiling portion 233 of the slot 232.

The slot 232 is defined in the sintered section 152 such that the slot 232 includes a base portion 238, a ceiling portion 233 and a common sidewall 240 and defines a receiving area 242, i.e. slot parameters. The bolt hole 230 may extend through both the base portion 238 and the ceiling portion 233.

The retaining detent 234 is defined in the receiving area 242 coupled to the base portion 238; however, the retaining detent may be coupled to any area within the slot 232. The retaining detent 234 is embodied as a ramp, such that the weld nut 236 may be received in the slot 232 by sliding the weld nut 236 over the retaining detent 234, which may recede into the base portion 238. The retaining detent 234 my recede through a spring mechanism or other mechanical mechanisms know in the art. The detent 234 springs outwardly to its initial position following the sliding of the weld nut 236 over the retaining detent. The weld nut 236 is then securely held between the retaining detent 234 and the slot parameters. The weld nut 236 may be removed through a disengaging operation including depressing of the retaining detent 234 with a screwdriver or through other mechanical means know in the art. The retaining detent 234 may include a notch 250 such that a screwdriver or depressing device may catch on the notch 250 to depress the retaining detent.

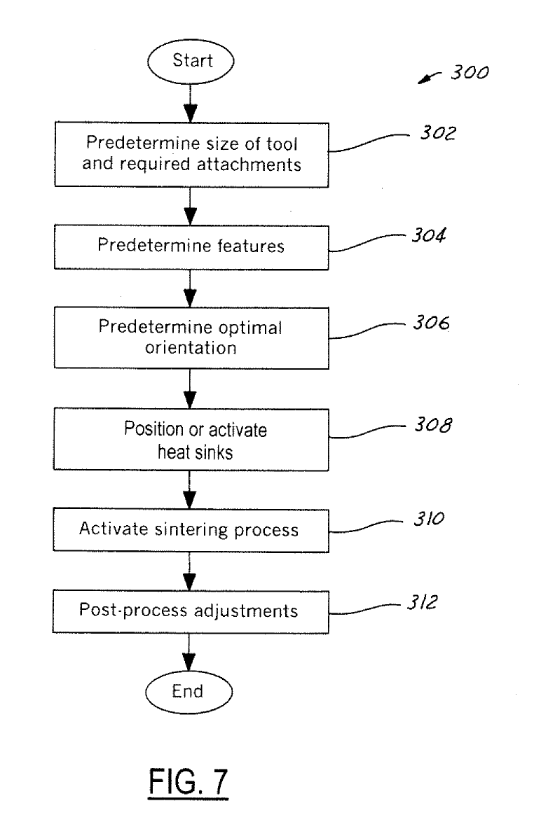

Referring to FIG. 7, logic flow diagram 300 of the method for operating a SLS system is illustrated. Logic starts in operation block 302 where the size of the tool needed is predetermined and attachments required to generate that size of tool are also predetermined. In other words, if the tool requires several sections due to the limitations of the part cylinder 102, the tool is manufactured in a plurality of parts that are joined together through predetermined connectors that are sintered into the sections within the parts cylinder 102.

In operation block 304, the features, such as thickness variations 158, gussets 160, stiffeners 162, interfaces and coordination features 164, construction ball interface and coordination holes 170, trim of pockets and drill inserts 166 and holes 168 provided in details for interface hardware, such as screws, are all predetermined for the tool.

In operation block 306, optimal orientation of the SLS tool design within the parts cylinder is predetermined. In one embodiment of the present invention, this predetermination involves including all features of the tool 150 on the same side of the tool, thereby limiting warping on tool features in accordance with the present invention.

In operation block 308 heat sinks, such as 202, 204, or 206, are positioned in various parts of the parts cylinder 102 such that tool features may be cooled immediately following the sintering process and while the rest of the tool or tool components are being sintered, thereby minimizing warping of the tool features. Alternate embodiments include activating the heat sinks 202, 204, 206 or alternately inputting them into the parts cylinder 102 prior to sintering. Further alternate embodiments include a single heat sink, or a heat sink activating in various regions corresponding to tool features on the tool being sintered.

In operation block 310 the sintering process is activated, and the controller 105 activates the pistons 114, 117, the roller 118, the laser 120, and the mirrors 124. The pistons force sinter material upwards or in a direction of the powder leveling roller 118, which rolls the sinter powder such that it is evenly distributed as a top layer on the parts cylinder 102. The laser 120 is activated and a beam 126 is directed towards scanning gears, which may be controlled as a function of predetermined requirements made in operation block 302. During the sintering operations, the heat sinks 202, 204, 206 are activated for cooling various sintered portions of the tool 150 as they are sintered, and as other parts of the tool are being sintered such that warping is minimized. In alternate embodiments wherein a plurality of tool sections, such as a first and second tool section, are sintered collectively or successively, heat sinks may be included to cool various features of the second tool section as well.

In operation block 312, post-sintering process adjustments are conducted. These adjustments include removing warped portions that were deliberately warped such that tool features would not undergo typical warping associated with the sintering process. Further, post-process adjustments involve fitting together components or sections of the tool 150.

In operation, a method for laser sintering a tool includes predetermining a position and a configuration for a slot on a first section of the tool and predetermining an orientation of the first section of the tool within the part chamber as a function of minimizing warping of parameters of the slot during sintering. The method further includes laser sintering the first section of the tool within the part chamber. A strengthening component is coupled within the slot for reducing stress on the first tool section.

Further, a position for a second tool feature on a contoured detail is predetermined, and an orientation of the contoured detail within the part chamber as a function of minimizing warping of the second tool feature during sintering is also predetermined. The contoured detail is laser sintered; and the contoured detail is coupled to the first section through bolting a bolt through a hole in the first tool section, such that the bolt intersects the slot in an area of the strengthening component and bolts to the strengthening component.

From the foregoing, it can be seen that there has been brought to the art a new and improved tooling system and method. It is to be understood that the preceding description of the preferred embodiment is merely illustrative of some of the many specific embodiments that represent applications of the principles of the present invention. Numerous and other arrangements would be evident to those skilled in the art without departing from the scope of the invention as defined by the following claims.

1. A sintering system comprising:
a tool chamber enclosing a sinter material;
a laser system sintering said sinter material as a function of controller signals; and
a controller generating said controller signals as a function of a predetermined tool section design defining a slot for receiving a strengthening component following sintering operations.

2. The system of claim 1, wherein said slot is further defined by a base, a ceiling, and a common sidewall.

3. The system of claim 2, wherein a bolt hole is defined extending through at least one of said base or said ceiling, wherein sides of said bolt hole are pre-designed to be either reinforced or to comprise only sinter material.

4. The system of claim 3, wherein said strengthening component comprises a weld nut such that said slot is pre-designed for securing said weld nut.

5. The system of claim 3, wherein controller further generates said controller signals as a function of said predetermined tool design comprising a retaining detent for securing said strengthening component.

6. The system of claim 5, wherein said retaining detent is moveable such that said strengthening component may slide over said retaining detent and be secured between said retaining detent and said common sidewall.

7. The system of claim 1, wherein said controller generates said controller signals as a function of defining a plurality of openings for receiving a plurality of strengthening components in said tool section.

8. The system of claim 1 further comprising a plurality of heat sinks positioned within said tool chamber for cooling a plurality of predetermined features of said tool section, thereby limiting warping of said plurality of predetermined features during sintering of said tool.

9. A method for constructing a tool comprising:
predetermining a position of a slot within a first tool section;
predetermining a configuration for said slot within said first tool section such that said first tool section comprises securing features for coupling strengthening components within said slot;
sintering said first tool section; and
coupling a strengthening component within said slot for reducing stress on said first tool section.

10. The method of claim 9 further comprising coupling a contoured detail to said first tool section.

11. The method of claim 10, wherein coupling said contoured detail to said first tool section comprises bolting a bolt through a hole in said first tool section such that said bolt intersects said slot in an area of said strengthening component and bolts to said strengthening component.

12. The method of claim 9, wherein predetermining said configuration for said slot within said first tool section such that said first tool section comprises securing features further comprises predetermining a position of a retaining detent for securing said strengthening component within said slot.

13. The method of claim 9, wherein coupling said strengthening component within said slot for reducing stress on said first tool section further comprises depressing a retaining detent and sliding said strengthening component over said retaining detent.

14. The method of claim 13, wherein depressing said retaining detent further comprises depressing said retaining detent with a tool, such as a screwdriver or similar device, through applying pressure to a notch defined on said retaining detent.

15. The method of claim 9 further comprising sintering a second tool section and coupling said second tool section to said first tool section.

16. The method of claim 15, wherein coupling said second section to said first section further comprises coupling a second strengthening component within a second slot defined in said second tool section.

17. The method of claim 9, wherein coupling said strengthening component further comprises coupling a weld-nut within said slot.

18. The method of claim 9, wherein sintering said first tool section further comprises sintering said first tool section defining a hole therein, a slot trans-axial with said hole, and a retaining detent for securing said strengthening component within said slot.

19. The method of claim 9 further comprising predetermining positions of a plurality of first section features.

20. The method of claim 19 further comprising orienting said first section within a sinter chamber such that all of said features are on a same side of said first section.

21. A sintering system comprising:
a part chamber enclosing a sinter powder;
a laser system sintering said sinter material as a function of controller signals; and
a controller generating said controller signals as a function of a predetermined tool design defining a slot by a base, a ceiling, and a common sidewall for receiving a weld-nut following sintering operations, said controller further generating signals as a function of a bolt hole defined extending through at least one of said base or said ceiling, wherein sides of said bolt hole are pre-designed to be either reinforced or to comprise only sinter material, wherein controller further generates said controller signals as a function of said predetermined tool design comprising a retaining detent for securing said strengthening component.

22. The system of claim 21, wherein said retaining detent is moveable such that said strengthening component may slide over said retaining detent and be secured between said retaining detent and said common sidewall.

23. The system of claim 21, wherein said controller generates said controller signals as a function of defining a plurality of openings for receiving a plurality of strengthening components in said tool section.

24. The system of claim 21 further comprising a plurality of heat sinks positioned within said tool chamber for cooling a plurality of predetermined features of said tool section, thereby limiting warping of said plurality of predetermined features during sintering of said tool.

25. The system of claim 21 further comprising a first heat sink positioned within said tool chamber for cooling at least one of a plurality of predetermined features of a tool on said first tool section, thereby limiting warping of said at least one of said plurality of predetermined features during sintering of said tool, wherein said plurality of predetermined features comprise at least one of a step and thickness variation, a gusset, a stiffener, an interface and coordination feature for making interfaces, a construction ball interface, a coordination hole, a trim of pocket and drill insert, a hole pattern, or a hole for interfacing hardware,
said controller further generating said controller signals as a function of said predetermined tool design, predetermined positions of said plurality of tool features, and a predetermined orientation of said tool section within said part chamber as a function of minimizing warping of said tool features during sintering, wherein said predetermined tool design comprises a buffer feature protecting at least one of said plurality of predetermined features such that said buffer feature is primarily affected by heat generated during sintering in an area of said at least one of said plurality of predetermined features, wherein said plurality of predetermined features is designed on a same side of said tool.

26. A method for laser sintering a tool comprising:
predetermining a position and a configuration for a slot on a first section of the tool;
predetermining an orientation of said first section of the tool within the part chamber as a function of minimizing warping of parameters of said slot during sintering;
laser sintering said first section of the tool within said part chamber;
coupling a strengthening component within said slot for reducing stress on said first tool section;
predetermining a position for a second tool feature on a contoured detail;
predetermining an orientation of said contoured detail within said part chamber as a function of minimizing warping of said second tool feature during sintering;
laser sintering said contoured detail; and
coupling said contoured detail to said first section through bolting a bolt through a hole in said first tool section such that said bolt intersects said slot in an area of said strengthening component and bolts to said strengthening component.

27. The method of claim 26, wherein predetermining said configuration for said slot within said first tool section such that said first tool section comprises securing features further comprises predetermining a position of a retaining detent for securing said strengthening component within said slot.

28. The method of claim 26, wherein coupling said strengthening component within said slot for reducing stress on said first tool section further comprises depressing a retaining detent and sliding said strengthening component over said retaining detent.

29. The method of claim 28, wherein depressing said retaining detent further comprises depressing said retaining detent with a tool, such as a screwdriver or similar device, through applying pressure to a notch defined on said retaining detent.

30. The method of claim 26 further comprising sintering a second tool section and coupling said second tool section to said first tool section.

31. The method of claim 26, wherein coupling said second section to said first section further comprises coupling a second strengthening component within a second slot defined in said second tool section.

32. The method of claim 26, wherein coupling said strengthening component further comprises coupling a weld-nut within said slot.

33. A tool system comprising:
a first tool section, manufactured through a first sintering process, defining a slot having a base, a ceiling, and a common sidewall, said first section further defining a bolt hole extending through at least one of said base or said ceiling; and
a weld-nut received in said slot following said first sintering process.

34. The system of claim 33, wherein said first section further comprises a retaining detent for securing said weld-nut within said slot.

35. The system of claim 34, wherein said retaining detent is moveable such that said strengthening component may slide over said retaining detent and be secured between said retaining detent and said common sidewall.

36. The system of claim 33, wherein sides of said bolt hole are reinforced.

37. The system of claim 33 further comprising a first contoured detail manufactured through a second sintering process, said first contoured detail coupled to said first tool section.

38. The system of claim 37, wherein said first contoured detail defines an opening, whereby a bolt extends through said opening and said bolt hole in said first tool section and is bolted to said weld-nut within said slot.

39. The system of claim 33, wherein said first section further comprises at least two mating edges, each of said edges comprising a joint feature.

40. The system of claim 33, wherein said contour detail is coupled to said first section through either a sintered bolt or a standard bolt or bolting system.
